(19) United States
(12) Patent Application Publication
(10) Pub. No.: US 2013/0340308 A1
(43) Pub. Date: Dec. 26, 2013

(54) Adhesive Interlocking Mounting Track

(71) Applicant: Dane Fette, Windermere, FL (US)

(72) Inventor: Dane Fette, Windermere, FL (US)

(21) Appl. No.: 13/920,608

(22) Filed: Jun. 18, 2013

Related U.S. Application Data
(60) Provisional application No. 61/663,252, filed on Jun. 22, 2012.

(51) Int. Cl. G09F 7/18

(52) U.S. Cl. CPC G09F 7/18
USPC 40/594; 40/606.01

(57) ABSTRACT

An adhesive interlocking mounting track for removably securing a sheet of semi-rigid or rigid material to a building structure. The mounting track is comprised of a base member and a locking member that snap together. When the two pieces are in engagement a retention channel is formed between then, for holding a relatively flat sheet of material. The mounting track is secured to the interior of a window or doorframe via a coat of adhesive on the back of an attachment plate portion of the base member. Thus the device is an easy to install material retention means. Additionally, it can be applied to the interior of a frame to recess the retained sheet of material and reduce its exposure to the environment.

### CROSS REFERENCE TO RELATED APPLICATION

This application claims the benefit of U.S. Provisional Application No. 61/663,252 filed on Jun. 22, 2012, entitled “Window Attachments.” The patent application identified above is incorporated here by reference in its entirety to provide continuity of disclosure.

### BACKGROUND OF THE INVENTION

1. Field of the Invention

The present invention relates to means for mounting signs to a window frame. More specifically, it relates to a mounting track having multiple interlocking pieces that adhesively secure to a window frame. When the pieces are attached to a window frame and snapped into engagement with each other, they hold a portion of a sign. Several tracks may be mounted around the window frame to hold different edges of the sign, preventing it from displacement.

Building structures such as windows, doorframes, and archways have many uses other than as entryways. Windows and doors are common places to hang a sign or advertisement. Shopkeepers and businesspeople often use these entryways to display temporary signs such as those associated with special events. Entryways are also used by construction workers to hang plywood or cardboard to protect non-construction areas from dirt and debris. Homeowners who do not frequently use an entryway may choose to cover it with thermal insulation to reduce the amount of heat that escapes through the passage. These examples are just a few of the many uses for building openings.

A common problem with alternative uses for window frames and doorframes is providing stable support of materials hung in the frame. Hooks are sometimes used to hang signs, but they do not keep the object from moving around and require the drilling of holes into the frame. Tape is often used to secure cardboard or plywood to a window frame, but this method risks damaging the paint of the window frame, and is only temporary because the tape will eventually lose its adhesive quality. Metal mounting brackets are sometimes used but these require permanent modification to the underlying building structure. An easy to install solution is needed that can maintain a variety of materials in a secured position within a building opening.

2. Description of the Prior Art

The present invention relates to an interlocking mounting track that adhesively secures to a window frame. The track includes two pieces, a first track portion that removably secures to the window frame, and a second track portion that snaps into a receiving area of the first track portion. When the two portions are snapped into engagement they form a thin channel between which a piece of plastic, plexiglass, cardboard, wood, sheetmetal or the like can be retained. The prior art fails to describe a pair of track portions that snap together in interlocking engagement to form a mounting track that can adhere to a window frame and hold sheets of material of varied size and weight.

Some window-mountable sign holders secure directly to a windowpane. Lamothe, U.S. Patent Application Publication No. 2007/0107284 discloses a base that secures to a windowpane via several suction cups. A support rod attaches to the base and extends outward. Signs can be removably secured to the support rod by hangers. Though this is a convenient means for hanging a temporary sign, the Lamothe invention does not protect the sign from being displacement by weather conditions. Further, gravity can pull the suction cups off the window causing the sign to fall. The present invention addresses these problems by mounting the sign to the window frame so that the sign is recessed, protecting it from the wind. The present invention uses an interlocking track to immobilize the sign between two track supports, making it difficult for the sign to be displaced without force.

Diamond, U.S. Pat. No. 4,703,575 discloses a frame with mounting tracks at opposing ends. It is magnetic so that it can be removably joined with a magnetic sign. This makes it easy to change the sign out without moving the frame. The frame removably mounts to a windowpane via suction cups or other adhesive means. Unlike the present invention the mounting tracks of Diamond are part of the frame and are not freely positionable. The Diamond device can only be used with signs made of ferrous materials, whereas the present invention may be utilized with many types of materials.

Still other window advertising means exist in the art. These devices all suffer from the same drawbacks as Lamothe and Diamond in that they put their use can result in damage to the underlying windowpane. Scratches, chips, dings and even broken glass are potential problems associated with these devices. The present invention provides a means for mounting a sign within a window frame without bringing the sign our mounting means into direct contact with windowpanes. Thus the present invention provides a safe means for mounting a sign in a window area without risking damage to the underlying glass.

Sign hangers that secure to a window frame use pressure to trap the sign material between two parts of a mounting bracket. One such device is described in Meadows, U.S. Pat. No. 4,233,790 as a two-part extrusion forming a frame around a building structure such as a window. The main portion is secured to a wall or window frame and has a channel running along its entire length. A locking member has a portion that is shaped to engage and mate with the channel of the main portion. Sheets of thin plastic material can be stretched across the channel and then locked in place by pushing the locking member down into the channel. Herbst, U.S. Pat. No. 4,164,105 teaches another mounting device that traps thin sheets of pliant material. The Herbst device uses corner brackets to trap the sheet between grooves in the base portion and mating members in the corner bracket. A similar devices is described in Ruggeberg, U.S. Pat. No. 4,453,585. The cross-sectional shape of this device varies from that of Meadows, but they are used in the same manner. Both devices hold a think plastic sheet in place so that the sheet is deformed between mating parts of the device.

None of these devices is capable of holding onto sheets of materials such as sheet metal, wood, cardboard, or plexiglass because those materials can not deform to allow the two parts of the device to mate. The interlocking parts of the present mounting track engage at a portion of the track that is distal from the sheet of material. The engagement of the two parts does not affect the shape or positioning of the material. Rather the engagement simply forms a channel between the two parts in which the material is retained. Additionally, all of these devices trap a thin sheet of material in a position so that the sheet is orthogonal to the mounting track. This positioning is necessary because the sheet must be laid across a channel in the base prior to a locking member being pushed into the channel to trap the sheet of material. Because of this positioning the mounting track must be secured to an outer portion of a building structure. The result can be unsightly or prone to jostling. Conversely, the present invention holds a sign in parallel to the mounting track and orthogonal to the interior window frame. In this way the invention can be secured to the inside of a window frame, creating a cleaner more aesthetically pleasing look and protecting the mounting track and sign from jostling.

The present invention provides a unique means for mounting signs and thick sheets of material to the interior of a window frame. It substantially diverges in design elements from the prior art and consequently it is clear that there is a need in the art for an improvement to existing window sign mounting devices. In this regard the instant invention substantially fulfills these needs.

### SUMMARY OF THE INVENTION

In view of the foregoing disadvantages inherent in the known types of sign mounting tracks now present in the prior art, the present invention provides a new sign retention means wherein the same can be utilized for providing convenience for the user when mounting a sheet of material to a window frame.

The present invention is a two-piece interlocking mounting track for removably securing signs to a window frame. A first track portion serves as a base and has an adhesive surface at one end. The adhesive surface is used to secure the mounting track device to a window frame or other building structure. A second track portion is a locking member that engages with the base piece to form a tight connection between the two pieces. The engagement occurs between a ribbed securing portion on the locking member and a notched receiving portion on the base member. When the two pieces are joined together a channel is formed between them that accepts and retains an edge of a sheet of semi-rigid material. Stabilizing elements within the channel prevent the sheet of material from moving while it is held in place. The device can be removed via disengaging the two pieces and gently removing the base portion from the underlying structure. In this way, the invention provides a fast and secure way to display signs, mount storm windows, board up windows, and the like.

It is therefore an object of the present invention to provide a new and improved adhesive mounting track device that has all of the advantages of the prior art and none of the disadvantages.

It is therefore an object of the present invention to provide an interlocking mounting track that provides removable securement of a sheet of material to a window frame.

Another object of the present invention is to provide a mounting track that attaches to the interior of a window frame. This attachment positioning places a secured sheet of material within the recess of the window frame, where it is less likely to be jostled.

Yet another object of the present invention is to provide a mounting track that has interlocking pieces that form a channel for retaining a sheet of material.

Still another object of the present invention is to provide a mounting track that does not require surface tension to hold a sheet of material in place.

A further object of the present invention is to provide a mounting track that can be used to hold sheets of material of varied shapes and sizes.

A still further object of the present invention is to provide an adhesive mounting track that is durable and easily customizable.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows an overhead view of the two portions of the mounting track in a connected state. A sheet of plexiglass is secured between the two parts of the track.

FIG. 1B shows an overhead view of another embodiment of the interlocking mounting track device with a sheet of plexiglass held in place between the two parts.

FIG. 1C shows an overhead view of another embodiment of the interlocking mounting track device, with a curved connection bracket and an additional bracing arm.

FIG. 1D shows an overhead view of another embodiment of the interlocking mounting track device, with a curved connection bracket and an additional bracing arm.

FIG. 2A shows an overhead view of the base member of the mounting track.

FIG. 2B shows an overhead view of the locking member of the mounting track.

FIG. 3 shows a perspective view of a ticket booth window formed by securing mounting track along the interior of a window frame and securing a plexiglass window pane within the track. An exploded view is also provided showing the two pieces of the interlocking mounting track in use for holding a sheet of plexiglass.

### DETAILED DESCRIPTION OF THE INVENTION

Reference is made herein to the attached drawings. Like reference numerals are used throughout the drawings to depict like or similar elements of the adhesive mounting track. For the purposes of presenting a brief and clear description of the present invention, the preferred embodiment will be discussed as used for removably mounting a sign or sheet of semi-rigid material within a building frame. The figures are intended for representative purposes only and should not be considered to be limiting in any respect.

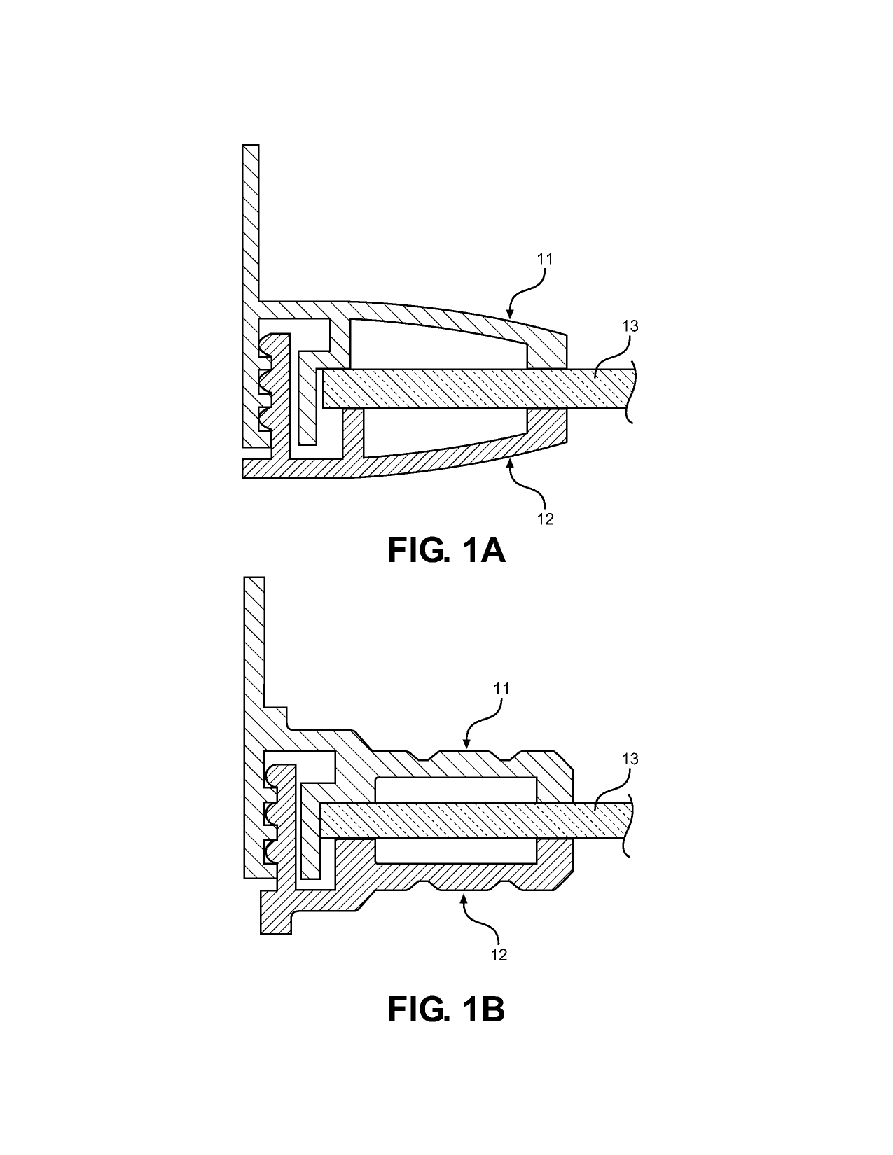

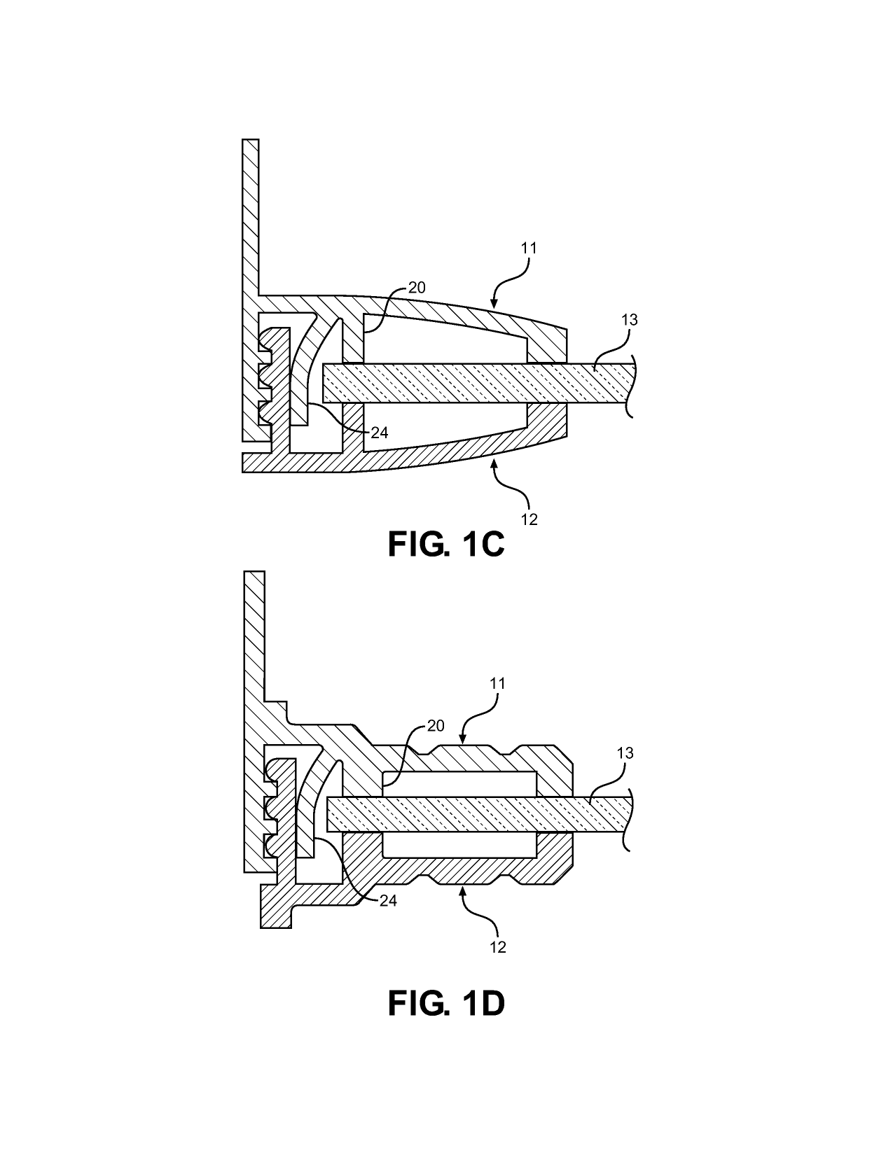

The embodiments of the primary invention are shown in FIGS. 1A through 1D. The adhesive mounting track has a base member 11 and a locking member 12. Near one end of each member is an engagement means for facilitating securement of the members together. The remaining length of each member is recessed such that a channel is formed when the two members are engaged. A semi-rigid sheet of material 13 is retained within the channel to prevent the sheet from shifting. In a first embodiment, as shown in FIG. 1A, the outer edge of each member may taper inward for improved retention of thinner sheets of material such as plastic signs. Larger sheets of material may be used with the non-sloping embodiment, as shown in FIG. 1B. This embodiment presents a larger retention channel and can thus accommodate thicker sheets of material such as plexiglass or wood panels. Other embodiments, shown in FIG. 1C and FIG. 1D, incorporate the sloped and straight arms of the first two embodiments but further provide a sloped connection brackets 24 and additional stabilizing arm 20 within the retention channel. In any embodiment, the sheet of material is held within the retention channel without deforming pressure from the mounting track members. The engagement means is separate from the retention channel, allowing for insertion of the sheet of material after engagement of the two members.

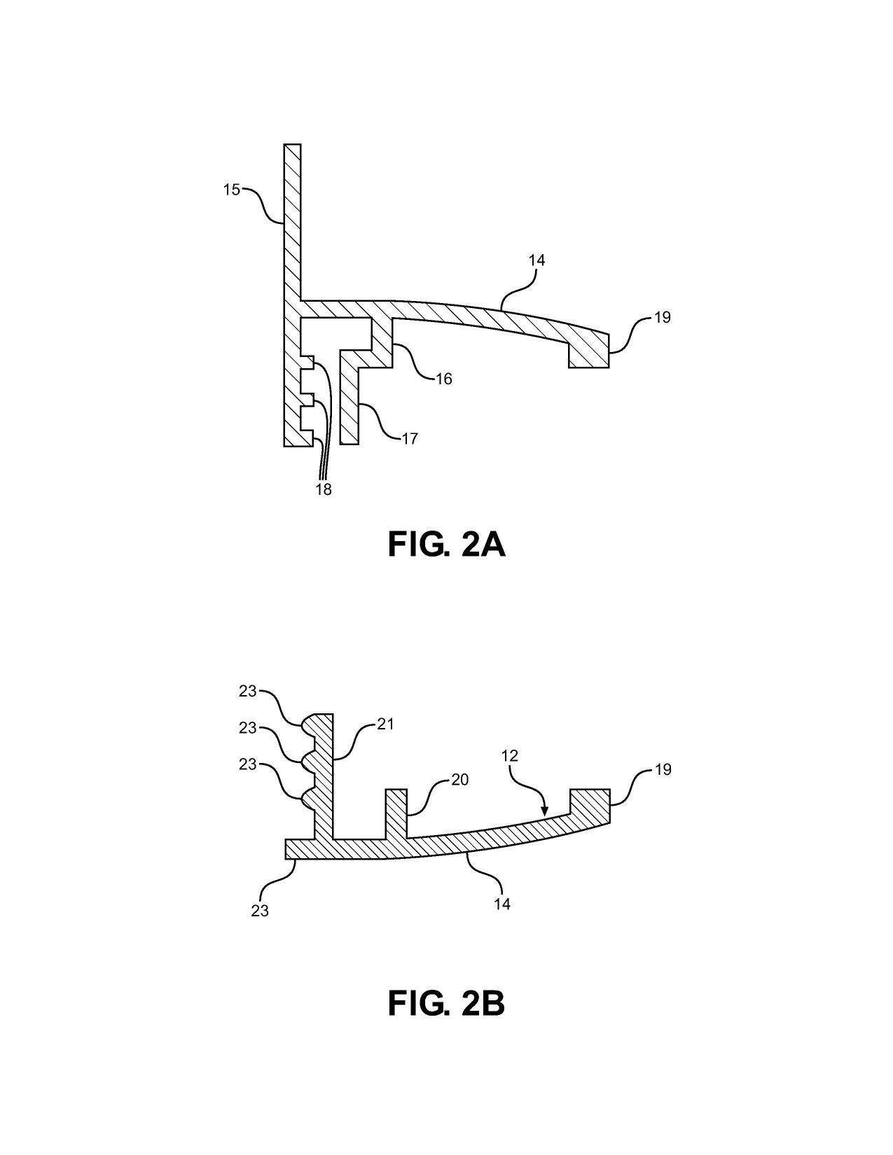

Referring now to FIG. 2A, there is shown an overhead view of the base member 11. An elongated arm 14 forms an outer boundary of the base member and has an attachment plate 15 at one end and a stabilizing extension 19 at an opposing end. The elongated arm has an inner and outer surface and may slope gently inward from the junction with the attachment plate to the stabilizing extension, or alternatively may extend straight from the attachment plate to the stabilizing extension.

The attachment plate 15 is an essential component of the invention because it provides a means for securing the mounting track to a building structure. The attachment plate has two opposing surfaces and any number of edges, as it may have any geometrical shape. A front surface of the plate is joined to the elongated arm 14 to form the primary structure of the base member. In a preferred embodiment the rear surface of the attachment plate is coated in an adhesive such as a pressure sensitive adhesive. A removable paper or plastic backing may be placed over the rear surface to protect the adhesive coating prior to use. When a user is ready to install the mounting track, the installation surface is cleaned, the backing removed from the attachment plate, and the base member is then pressed firmly onto the installation surface to secure the base member in place. Alternative embodiments of the invention may include an attachment plate with a rear surface that is not pre-coated, requiring the application of adhesive prior to installation of the device.

A connection bracket extends from the inner surface of the elongated arm located near the attachment plate. This connection bracket has two purposes; to assist the stabilizing extension 19 in preventing movement of a retained sheet of material, and to prevent the locking member from accidental disengagement once it is snapped into the base member. In a primary embodiment the connection bracket has an inner portion 16 joined to the inner surface of the elongated arm, and an outer portion 17 that is shifted in position towards the attachment plate. A modified “z” shape is formed by this configuration of the inner and outer portions. Thus, the inner portion has two long sides and a short side, the later being distal from the inner surface of the elongated arm. The outer portion has two long sides and two short sides. The short side of the inner portion aligns with the short side of the stabilizing extension and assists in preventing movement of a retained sheet of material. A front long side of the outer portion serves as the backstop of the retention channel. Sheets of material held within the retention channel are slid into an abutting position with the front long side of the outer portion to prevent the material from sliding backwards.

In an alternative embodiment the connection bracket 24 has only one portion. This embodiment is shown in FIGS. 1C & 1D as discussed above. The portion slopes towards the attachment plate starting from the junction with the inner surface of the elongated arm. The curvature of the connection means helps to prevent an abutting sheet of material from moving around, while also exerting pressure on the engaged locking member. A small ledge may be secured to the front side near the end of the connection bracket to further provide support for an object within the retention channel. To provide snug retention of materials within the retention channel, this embodiment also provides a stabilizing arm 20 that is secured to the inner surface of the elongated arm, next to the connection bracket.

An engagement means is formed from the attachment plate 15, the elongated arm 14, and a connection bracket 16,17. The connection between these elements of the base member forms a u-shaped area between the attachment plate and the connection bracket. Along the portion of the attachment plate front surface within the u shape is a plurality of securing bits 18. A corresponding set of securing bits is disposed along a securing arm of the locking member (not shown) for engaging with the securing bits on the base member. The locking member, securing arm is inserted into the u-shaped region and pushed inward until the two sets of securing bits mate, creating a removable engagement between the two members. These bits may be square or rounded to meet different needs of a user. For example, if a user desires the strong, long-term securement of a sheet of material, square bits will make it harder for the locking member to release from engagement. On the other hand, if the user desires a more easily removable engagement so that the sheet of material can be regularly switched out, the rounded bits may provide better disengagement.

The locking member, shown in FIG. 2B engages with the base member. An elongated arm 14 with an inner and outer surface is the backbone of the locking member. This elongated arm has a stabilizing extension 19 at one end, and a tail extension at an opposing 23 end. A securing arm 21 extends from the inner surface of the extension arm and has both a front and a rear long side, and a short side that is distal from the extension arm. A plurality of securing bits 22 is disposed along the rear side of the securing arm; the rear side being closest to the tail extension. These bits mate with the securing bits on the attachment plate of the base member to form an engagement. The connection bracket of the locking member presses up against the front surface of the securing arm while the two members are engaged, thereby holding the securing arm in place and preventing unforced disengagement.

A stabilizing arm 20 extends from the inner surface of the elongated arm 14 and is positioned near the front surface of the securing arm 21. The stabilizing arm has two long sides and a short side, which is distal from the inner surface of the elongated arm. The short side of the stabilizing arm aligns with the short side of the stabilizing extension, thereby providing two structural supports for a retained sheet of material. The stabilizing elements of the locking member combined with the stabilizing elements of the base member to prevent a sheet of material from jostling or rattling while the device is in use.

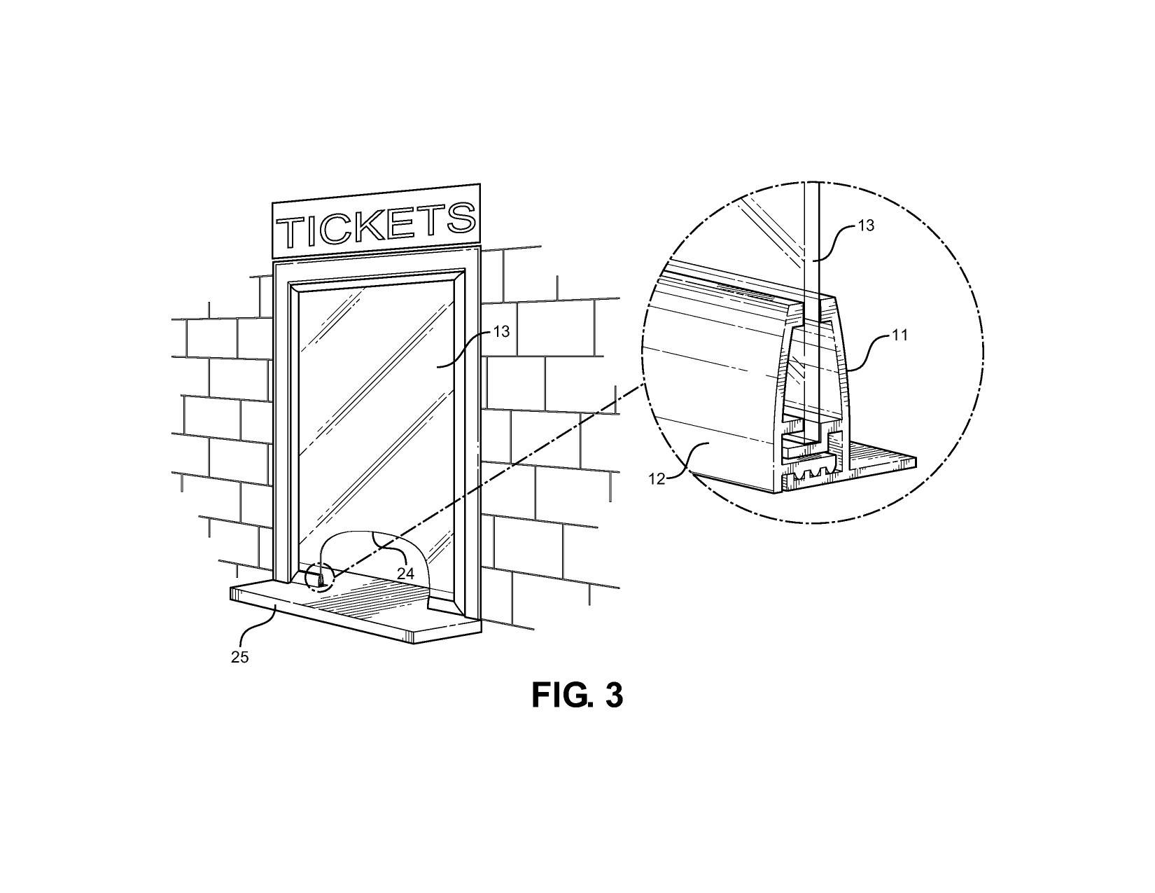

Turning now to FIG. 3 there is shown a ticket booth window formed from the assembled adhesive interlocking mounting track and a sheet of plexiglass 13. Several strips of the mounting track have been cut to fit the dimensions of the window frame interior and are secured thereto. Two small sections are attached at the bottom, along a ticket counter 25, and have a space between them creating an open area in the bottom of the window. This open area can be used to pass payment and tickets across the barrier. An exploded view of the plexiglass is shown, secured within the retention channel of the two interlocking pieces of the mounting track 11,12. The plexiglass sheet is retained in an upstanding position, perpendicular to the attachment plate of the base portion 11 and the underlying window frame. Though the end of the mounting track is shown in a vertical cut, the ends of the mounting track may be mitered or rounded.

In use an individual measures the dimensions of a window frame, doorframe, archway or other building structure. He then cuts pieces of the mounting track according to the measured dimensions. The protective backing is removed from the adhesive side of the base member attachment plate and the base member is secured into place along the interior of the building structure. This step is repeated until the base member portion of each piece of mounting track is in place. Next a user places a sheet of semi-rigid material into the base member retention channel half of each mounting track piece. Once the sheet of material is set within the recess of each track piece the user snaps the corresponding locking member into each base member to secure the two together and trap the edge of the sheet of material within the created retention channel. Alternatively, the user can snap all but one side of the mounting track together prior to inserting the sheet of material. In this method, the sides of mounting track that are already together create several retention channels that the sheet of material is slid into. The last locking member is snapped into placed to prevent the sheet of material from sliding back out of the retention channels. In this way, a secure but removable retention of the sheet of material is created.

The present invention is an adhesive interlocking mounting track that can be secured to the interior of many types of building structures. Two pieces having a particular shape snap together forming a retention channel between them. Sheets of semi-rigid or rigid material such as plastic, wood, cardboard, plexiglass, and the like, can be removably secured within the retention channel to hold the sheet in place within a building structure. A pre-treatment of pressure sensitive adhesive may be applied to the rear of the base member so that the mounting track can be applied to a building structure without the need for messy application of adhesives. Alternatively the adhesive may be applied manually, prior to installation of the mounting track. In this manner, the invention provides a versatile and easy to install means for holding signs, plexiglass windows, boards, thermal windows and so forth. It will be appreciated by shop owners who need to hang temporary window signs, construction workers who want to board up windows to prevent dust and debris from entering non-construction areas, homeowners wanting an added layer of thermal insulation on windows during the winter, and many others.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The members of the invention may be constructed from any type of durable, weather resistant, shock absorbent material such as plastic or rubber. Size of the mounting track and its respective pieces will vary according to the intended use and size of the underlying building structure. Larger or wider pieces may be needed to accommodate thick sheets of material, while thin, small pieces may be more desirable for small window frames.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An interlocking mounting track comprising:
a base member comprising,
an elongated arm with an inner and outer surface and a first and second end;
an attachment plate secured to and extending from said first end of said base member elongated arm, wherein said attachment plate has a front side and rear side;
a stabilizing member extending from said inner surface of said second end of said base member elongated arm;
a connection bracket secured to said inner surface of said base member elongated arm and positioned near said attachment plate;
a first plurality of securing nubs disposed along said front side of said attachment plate;
a locking member;
an elongated arm with an inner and outer surface and a first and second end;
a stabilizing member extending from said inner surface of said second end of said locking member elongated arm;
a tail extension located at said first end of said locking member elongated arm;
a securing arm extending downward from said inner surface of said locking member elongated arm and having front and rear side;
a stabilizing arm extending from said inner surface of said locking member elongated arm and positioned between said securing arm and said locking member stabilizing extension;
a second plurality of securing nubs disposed along a rear side of said securing arm;
said locking member removably securing to said base member via insertion of said locking member securing arm in between said base member attachment plate and said base member connection bracket such that said first plurality of securing nubs engages with said second plurality of securing nubs.

2) The device of claim 1, wherein a retention is channel is formed between said locking member and said base member when said members are engaged.

3) The device of claim 2, wherein said retention channel is perpendicular to said base member attachment plate.

4) The device of claim 2, wherein said locking member stabilizing, said locking member stabilizing extension, and said base member stabilizing extension extend into said retention channel.

5) The device of claim 1, wherein said locking member elongated arm and said base member elongated are curved.

6) The device of claim 1, wherein said locking member elongated arm and said base member elongated run in parallel.

7) The device of claim 1, wherein said connection bracket comprises an inner portion secured to said inner surface of said base member elongated arm, and an outer portion, wherein said outer portion is positionally displaced from said inner portion, forming a Z shape.

8) The device of claim 1, wherein said connection bracket is curved towards said base member attachment plate.

9) The device of claim 1, wherein said rear surface of said base member attachment plate is pre-treated with an adhesive.

10) The device of claim 10, wherein said adhesive is pressure sensitive.
